(19) United States
(12) Patent Application Publication
(10) Pub. No.: US 2026/0030957 A1
(43) Pub. Date: Jan. 29, 2026

(54) METAMORPHING ELECTRONIC GAME

(71) Applicant: IGT, Las Vegas, NV (US)

(72) Inventors: Soheil Latifi, Brampton (CA); Stefan Keilwert, St. Josef (AT); Sven Aurich, Schwanberg (AT); Gaurav Jariwala, Halifax (CA); Michael Russ, Graz (AT)

(21) Appl. No.: 18/785,762

(22) Filed: Jul. 26, 2024

(51) Int. Cl. G07F 17/32

(52) U.S. Cl. CPC G07F 17/3227; G07F 17/3213; G07F 17/3237

(57) ABSTRACT

Embodiments of the present disclosure are directed to updating an electronic game. More specifically, embodiments described herein comprise an Artificial Intelligence (AI) module that constantly monitors social and other media, e.g., Instagram, Facebook feeds etc., then identifies pop culture topics and elements that are going to attract most of our game players' attention. The system can then apply content elements related to the identified topics to the electronic game. The electronic game thus changes to the new content so the players can enjoy newly designed games all the time.

### BACKGROUND

The present disclosure is generally directed to electronic games and more particularly to automatically updating the content of an electronic game.

Usually, electronic games come and go and most fail to keep a persistent performance. Ideally a game should always be trending. In theory, a game can maintain a steady performance if it never gets old, and always matches the trends. For example, as pop culture changes rapidly, game producers monitor these changes and release appropriate games quickly before these trends fade away. However, this process is expensive when done manually.

### BRIEF SUMMARY

Embodiments of the present disclosure are directed to automatically updating the content of an electronic game. According to one embodiment, a method for updating an electronic game can comprise collecting, from a plurality of information sources, information related to current events. For example, the plurality of information sources can comprise a news feed, a social media feed, a search engine, and/or others. A diffusion model can be trained with the collected information related to current events.

A topic of interest can be identified from the collected information related to current events. Content elements for the electronic game can then be generated based on the identified topic of interest and the diffusion model. The electronic game can then be updated with the generated content elements. For example, updating the electronic game with the generated content items can comprises changing a theme for the electronic game. The generated content items can comprise a graphic, an animation, audio, etc.

According to another embodiment, a system can comprise a processor and a memory coupled with and readable by the processor. The memory can store therein a set of instructions which, when executed by the processor, causes the processor to collect from a plurality of information sources, information related to current events and train a diffusion model with the collected information related to current events.

For example, the collected information related to current events comprises images. In such cases, training the diffusion model with the collected information related to current events can further comprise introducing noise to the images prior to training the diffusion model with the images. In other examples, the collected information related to current events can comprise video, audio, social media content, search engine keywords, and/or others.

The instructions can further cause the processor to identify a topic of interest from the collected information related to current events, generate content elements for the electronic game based on the identified topic and the diffusion model, and update the electronic game with the generated content elements.

According to yet another embodiment, a system can comprise a communications network, a gaming system coupled with the communications network and executing an electronic game, the electronic game comprising a plurality of content elements, and a game content host system coupled with the communications network. The game content host system can comprise a processor and a memory coupled with and readable by the processor and storing therein a set of instructions which, when executed by the processor, can cause the processor to collect from a plurality of information sources, information related to current events, train a diffusion model with the collected information related to current events, identify a topic of interest from the collected information related to current events, generate a plurality of updated content elements for the electronic game based on the identified topic and the diffusion model, and apply the plurality of updated content elements to the electronic game.

For example, the plurality of information sources can comprise information sources for a geographic location in which the gaming system is installed. The plurality of content elements of the electronic game can represent a theme for the electronic game and the plurality of updated content elements represent a new theme for the electronic game related to the identified topic of interest. In some cases, the instructions can further cause the processor to, prior to applying the plurality of updated content elements to the electronic game, provide the plurality of updated content elements as a recommendation for a change to the electronic game.

Additional features and advantages are described herein and will be apparent from the following Description and the figures.

### BRIEF DESCRIPTION OF THE SEVERAL VIEWS OF THE DRAWINGS

FIG. 1 is a block diagram illustrating an exemplary environment in which embodiments of the present disclosure can be implemented.

FIG. 2 is a block diagram illustrating additional details of components of an exemplary game content host system according to one embodiment of the present disclosure.

FIG. 3 is a block diagram illustrating additional details of components of an exemplary gaming system according to one embodiment of the present disclosure.

FIG. 4 is a flowchart illustrating an exemplary process for updating an electronic game according to one embodiment of the present disclosure.

FIG. 5 is a flowchart illustrating an exemplary process for updating an electronic game according to another embodiment of the present disclosure.

### DETAILED DESCRIPTION

Embodiments of the present disclosure are directed to updating an electronic game. Generally speaking, embodiments described herein are directed to “metamorphing” gaming system. This does not have a fixed theme assigned to it, but rather changes the content, theme, design, etc. with trending pop culture elements. For example, if a UFC match is getting a lot of attention from the media, this gaming system and content elements of the electronic game(s) executed therein can be “morphed” or updated with elements related to pop culture topic of interest, in this case the UFC match fighters.

More specifically, embodiments described herein comprise an Artificial Intelligence (AI) module that constantly monitors social and other media, e.g., Instagram, Facebook feeds etc., then identifies pop culture topics and elements that are going to attract most of our game players' attention. The system can then apply content elements related to the identified topics to the electronic game. The electronic game thus changes to the new content so the players can enjoy newly designed games all the time.

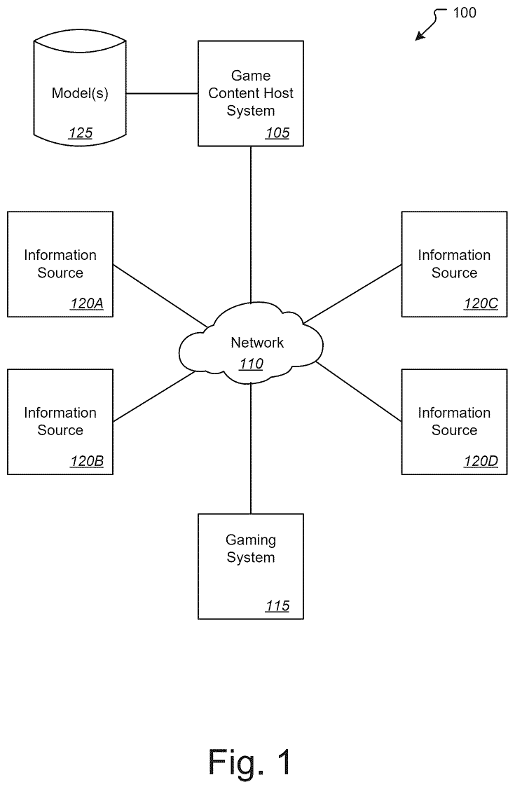

FIG. 1 is a block diagram illustrating an exemplary environment in which embodiments of the present disclosure can be implemented. As illustrated in this example, the environment 100 can comprise a game content host system 105 coupled with a communications network 110. Generally speaking, the game content host system 105 can comprise any one or more servers and/or other computing devices as known in the art and which may be used, for example, by an electronic game design studio. The communications network 110 can comprise any one or more wired and/or wireless, local-area and/or wide-area networks as known in the art including, but not limited to, the Internet.

Also coupled with the communications network 110 can be any number of gaming systems 115. Generally speaking, each gaming system 115 can comprise, for example, any Electronic Gaming Machine (EGM), kiosk, or similar gaming system as may be found in a casino or other gaming venue. The gaming system 115 can each execute any of a variety of electronic games including, but not limited to slots, video slots, video poker, keno, etc.

Also coupled with the communications network can be any number of information sources 120A-120D. Generally speaking, these information sources 120A-120D can comprise any source of electronic information of any type including, but not limited to, social media sources, news and/or other current events related sources, search engines or other sources providing information such as recent search topics and trends or similar. The game content host system 105 can collect various types of information from any number of such sources. The information collected from such sources can comprise text, images, video, audio, and/or other types of information. According to one embodiment, the information collected can relate to and be used by the game content host system to identify topics of current interest, e.g., news topics, pop culture topics and/or trends, etc. As will be described, the game content host system can train one or more models 125 using this collected information and, based on the model(s) 125 and identified topics of interest, generate content elements for use in an electronic game executed by the gaming system 115.

More specifically, the game content host system 105 can comprise two AI modules. One AI module can scan information sources 120A-120D for mainstream events or hot topics, such as based on Google Search evaluation, e.g., “Current hot search topics,” and decide or propose which to implement into the electronic game. Another AI module can be based on image processing and content generation. This second module can receive the first module's output, i.e., hot topics, as input and can create content elements, e.g., graphics, animations, audio, etc., for the game. The operator of the casino or other gaming venue in which the gaming system 115 is installed can let the game content host system update the electronic game on the gaming system autonomously or can receive recommendations to then apply manually or after approval.

According to one embodiment, a diffusion model can be used to generate these content elements. Training data for this model can be images from the ongoing trending news on the information sources. At the training time, the diffusion model can be trained to generate the image from the noised image. The noised image can be the target image with gaussian noise added to it. This process can train the model to generate images in the context of the recent event and the model can be constantly trained with the new trends popping up on the media. The result can be generated, fake images that match the context of the trending pop culture events. These images can then be incorporated in the electronic game with a few adjustments.

According to one embodiment, the game update features described herein can be made available top players on the gaming system based on eligibility. For example, eligibility could be based on a premium membership, paid subscription, or player loyalty, e.g., based on number of casino visits, revenue creation, etc., and enabled for loyal players for free. In some cases, a player might initiate the game update feature and it would start updating immediately. However, in some cases, it might require the player to play several spins to complete the change, with a certain number of spins or similar it would change a little bit more.

According to one embodiment, the metamorphosis or update might be activated by the game similar to a feature. As described above, it may require the player to keep playing to finalize the change. Any wins achieved while the metamorphosis is incomplete, might be booked to a separate cash meter and may only be cashed out once the metamorphosis has finished. This can be considered similar to progressive features, but here, the whole game is changing from one game to another. Alternatively, there might be specific “metamorphosis wins” which get booked on the separate meter, becoming cash out eligible. Regular wins could also be cashed out during the metamorphosis.

According to one embodiment, there can be different levels of subscription that allow the player to revise back to previous years to enjoy the pop elements that were trending back then. For example, if this gaming system is released today, it may have a theme mashed between Barbie and Oppenheimer, the movies that are on the top ten charts of grossing movies of all time. In some cases, the system could allow the player select from a date range they are interested in the most, not necessarily brand new but old school or classic.

According to one embodiment, games can be subject-specific like “sports metamorphing game” that adapt the designs to the trending subjects focused on different sports. In some cases, content creators may collaborate with game providers to use the game update feature as a form of advertisement.

According to one embodiment, game updates can be region specific based on information sources for a geographic region in which the gaming system is located. Then, depending on the region, the game can follow the trends of the specific region.

According to one embodiment, the gaming system 115 can be decorated with LEDs or various other types of lights or light panels. In this case, the LEDs or lights can change to show the current change state, e.g., percent change, of the game.

According to one embodiment, the game content host system can identify player clusters of a target market. Clusters can be enriched with environmental, socio-cultural information, player habits etc. Proposed topics of interest can be verified against player clusters to determine and predict an impact if content elements related to the topic is integrated into a game. This can be used to configure or train the AI to pick up or avoid specific content sources and/or topics geographically, topic-related, time-related, certain visual, audio, channels, etc. Example sources can include, but are not limited to, keywords, search engines, social media hot views, tv-news, trends on the casino-floor such as slot occupancy, local sport or music events etc.

According to one embodiment, a mobile device of the player can be used to provide additional information. For example, if the player uses his mobile device to connect to a gaming system, the gaming system can ask him to get access to his pictures and other data and present him what new game content can be created with his data. If the type of the mobile device is known, the player can be put into a cluster. If access to the player's Spotify list is granted, the player's favorite music can be known.

According to one embodiment, game updates can be integrated with Augmented Reality/Virtual Reality (AR/VR) elements. Such integration can allow players to be immersed in a metamorphosis theme world.

According to one embodiment, progressive jackpot opportunities can be created that can be tied to game updates or transformations. For example, hitting a specific sequence of transformations can lead to big jackpot win.

According to one embodiment, “society hot topics” can be blended with “personalized topics.” Current movies, region-specific content, market cluster content, etc. mentioned above can be can be considered to fall under “society hot topics.” A player could be provided with a few “society hot topics” to select from which they are interested, e.g., similar to songs/genres within YouTube Music. The player can select as many as wanted to generate a personalized profile. Utilizing that personalized profile can increase accuracy of future proposed topics for the player. Additionally, personalized profiles from players in a certain venue might be blended together to generate venue-specific “hot topics” based on personalization rather than on “society hot topics.” This might differ significantly from the “society hot topics.” Personalized topic inspirations and order of appearance for the actual player can be based on personalized topic selections from other like-minded players. Personalized topics can be saved to the player's profile, e.g., tracking card, or similar, and recognized upon logging in to a gaming system.

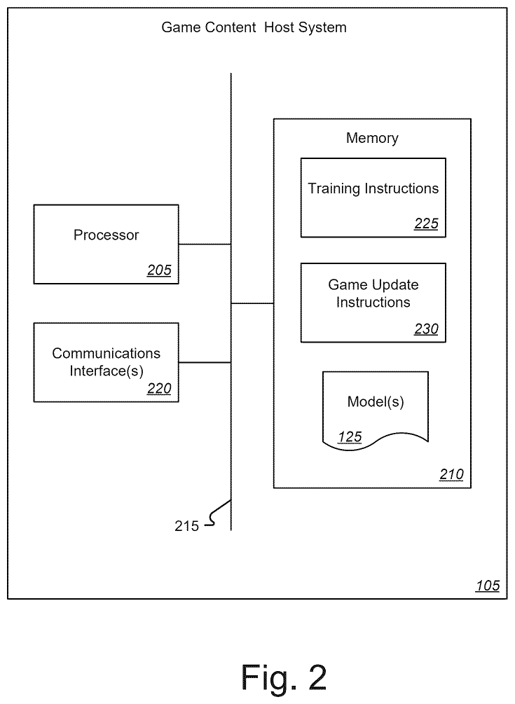

FIG. 2 is a block diagram illustrating additional details of components of an exemplary game content host system according to one embodiment of the present disclosure. As illustrated in this example, a game content host system 105 such as described above can comprise a processor 205. The processor 205 may correspond to one or many computer processing devices. For instance, the processor 205 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 205 may be provided as a microprocessor, Central Processing Unit (CPU), or plurality of microprocessors that are configured to execute the instructions sets stored in a memory 210. Upon executing the instruction sets stored in memory 210, the processor 205 enables various functions of the game content host system 105 as described herein.

The memory 210 can be coupled with and readable by the processor 205 via a communications bus 215. The memory 210 may include any type of computer memory device or collection of computer memory devices. Non-limiting examples of memory 210 include Random Access Memory (RAM), Read Only Memory (ROM), flash memory, Electronically-Erasable Programmable ROM (EEPROM), Dynamic RAM (DRAM), etc. The memory 210 may be configured to store the instruction sets depicted in addition to temporarily storing data for the processor 205 to execute various types of routines or functions.

The processor 205 can also be coupled with one or more communication interface(s) 220 via the communications bus 215. The communication interface(s) 220 can comprise, for example, an Ethernet, Bluetooth, WiFi, cellular, and/or other type of wired and/or wireless communications interface. Via the communication interface(s) 220, the game content host system 105 can communicate with other devices and/or systems through a communications network 115 as described above.

The memory 210 can store therein a set of game update instructions 225 which, when executed by the processor 205, cause the processor 205 to collect, through the communications interface(s) 220, from a plurality of information sources 120A-120D, information related to current events. For example, the plurality of information sources 120A-120D can comprise a news feed, a social media feed, a search engine, and/or others. In some cases, the plurality of information sources 120A-120D can comprise information sources for a geographic location in which the gaming system 115 is installed. The collected information related to current events can comprise images, video, audio, social media content, search engine keywords, and/or others.

The memory 210 can further comprise a set of training instructions 225 stored therein. The training instructions 225, when executed by the processor 205, can cause the processor 205 to train a diffusion model 125 with the collected information related to current events. In the case in which the collected information comprises images, training the diffusion model 125 with the collected information related to current events can further comprise introducing noise to the images prior to training the diffusion model with the images.

The game update instructions 230 can further cause the processor 205 to identify a topic of interest from the collected information related to current events, e.g., based on commonly occurring words, phrases, images, sounds, etc. The game update instructions 230 can further cause the processor 205 to generate content elements for the electronic game based on the identified topic of interest and the diffusion model. The generated content items can comprise a graphic, an animation, audio, etc. The game update instructions 230 can further cause the processor 205 to update the electronic game with the generated content elements, e.g., by providing the content elements to the gaming system 115 through the communications interface(s) 220. For example, updating the electronic game with the generated content items can comprise changing a theme for the electronic game.

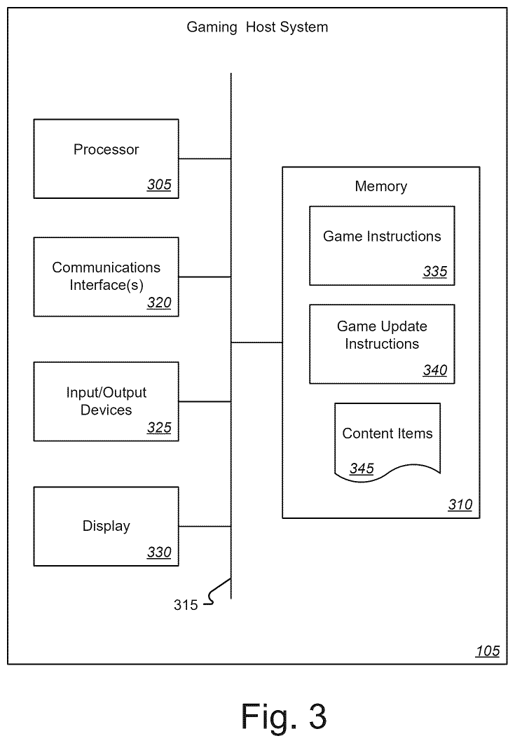

FIG. 3 is a block diagram illustrating additional details of components of an exemplary gaming system according to one embodiment of the present disclosure. As illustrated in this example, a responsible gaming system 125 can comprise a processor 305 such as any of the various types of processors described above. A memory 310 can be coupled with and readable by the processor 305 via a communications bus 315. The memory 310 can comprise any one or more of the different types of volatile and/or non-volatile memories described above. The processor 305 can also be coupled with one or more communication interfaces 320, one or more input/output devices 325, and a display 330. The communication interfaces 320 can comprise, for example, an Ethernet, Bluetooth, WiFi, cellular, and/or other type of wired and/or wireless communications interface. The input/output devices 225 can include, but are not limited to, buttons, speakers, a ticket printer, one or more cameras, microphones, etc. The display can comprise a Liquid Crystal Display (LCD), Light Emitting Diode (LED), Organic Light Emitting Diode (OLED), or other type of display.

The memory 310 can store therein a set of game instructions 335 which, when executed by the processor 305, cause the processor 305 to execute an electronic game. The memory can also store therein a set of game update instructions 340 which, when executed by the processor 305, can cause the processor 305 to receive generated content items 345 from the game content host system 105 and for use in the electronic game executed by the game instructions 335.

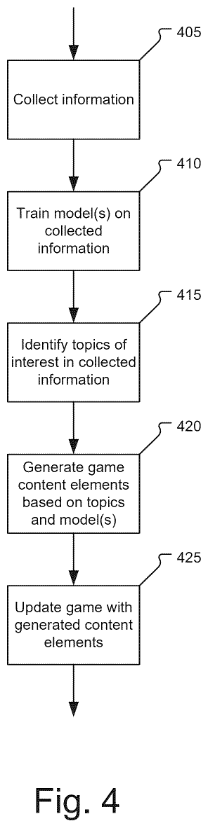

FIG. 4 is a flowchart illustrating an exemplary process for updating an electronic game according to one embodiment of the present disclosure. As illustrated in this example, updating an electronic game can comprise collecting 405, from a plurality of information sources 120A-120D, information related to current events. For example, the plurality of information sources 120A-120D can comprise a news feed, a social media feed, a search engine, and/or others. In some cases, the plurality of information sources 120A-120D can comprise information sources for a geographic location in which the gaming system 115 is installed. The collected information related to current events can comprise images, video, audio, social media content, search engine keywords, and/or others.

A diffusion model can be trained 410 with the collected information related to current events. In the case in which the collected information comprises images, training 410 the diffusion model with the collected information related to current events can further comprise introducing noise to the images prior to training the diffusion model with the images.

A topic of interest can be identified 415 from the collected information related to current events, e.g., based on commonly occurring words, phrases, images, sounds, etc. Content elements for the electronic game can then be generated 420 based on the identified topic of interest and the diffusion model. The generated content items can comprise a graphic, an animation, audio, etc. The electronic game can then be updated 425 with the generated content elements. For example, updating 425 the electronic game with the generated content items can comprise changing a theme for the electronic game.

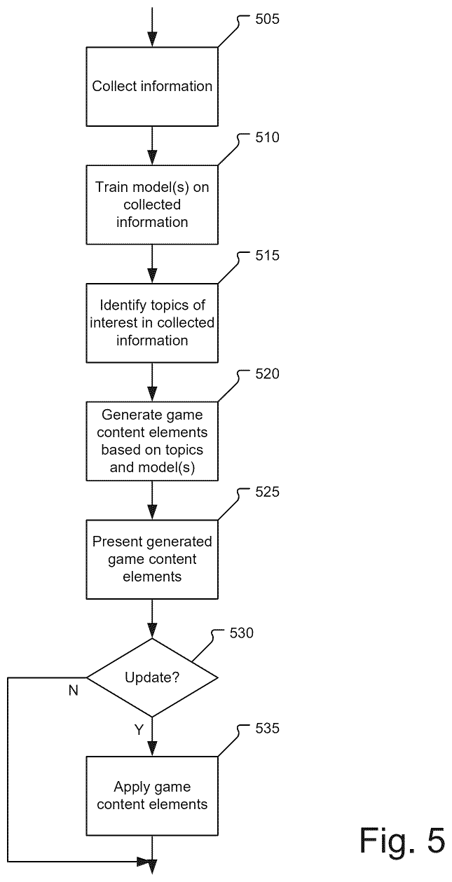

FIG. 5 is a flowchart illustrating an exemplary process for updating an electronic game according to another embodiment of the present disclosure. As illustrated in this example, updating an electronic game can comprise collecting 505, from a plurality of information sources 120A-120D, information related to current events. For example, the plurality of information sources 120A-120D can comprise a news feed, a social media feed, a search engine, and/or others. In some cases, the plurality of information sources 120A-120D can comprise information sources for a geographic location in which the gaming system 115 is installed. The collected information related to current events can comprise images, video, audio, social media content, search engine keywords, and/or others.

A diffusion model can be trained 510 with the collected information related to current events. In the case in which the collected information comprises images, training 510 the diffusion model with the collected information related to current events can further comprise introducing noise to the images prior to training the diffusion model with the images.

A topic of interest can be identified 515 from the collected information related to current events, e.g., based on commonly occurring words, phrases, images, sounds, etc. Content elements for the electronic game can then be generated 520 based on the identified topic of interest and the diffusion model. The generated content items can comprise a graphic, an animation, audio, etc.

As illustrated in this example, prior to applying the plurality of updated content elements to the electronic game, the plurality of updated content elements can be provided as a recommendation for a change to the electronic game. For example, the content elements can be displayed to a user for review and approval. Accordingly, a determination 530 can be made as to whether the content elements have been approved and should be applied. In response to determining 530 that the content elements have been approved, the electronic game can then be updated 535 with the generated content elements.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (c) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Pat. No. 8,764,566, entitled “Internet Remote Game Server,” and U.S. Pat. No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A method for updating an electronic game, the method comprising:
collecting, by a processor of a host system, from a plurality of information sources, information related to current events;
identifying, by the processor of the host system, a topic of interest from the collected information related to current events;
generating, by the processor of the host system, content elements for the electronic game based on the identified topic and a diffusion model; and
updating, by the processor of the host system, the electronic game with the generated content elements.

2. The method of claim 1, wherein the plurality of information sources comprises a news feed.

3. The method of claim 1, wherein the plurality of information sources comprises a social media feed.

4. The method of claim 1, wherein the plurality of information sources comprises a search engine.

5. The method of claim 1, further comprising training the diffusion model with the collected information related to current events.

6. The method of claim 1, wherein updating the electronic game with the generated content items comprises changing a theme for the electronic game.

7. The method of claim 1, wherein the generated content items comprise a graphic.

8. The method of claim 1, wherein the generated content items comprise an animation.

9. The method of claim 1, wherein the generated content items comprise audio.

10. A system comprising:
a processor; and
a memory coupled with and readable by the processor and storing therein a set of instructions which, when executed by the processor, causes the processor to:
collect from a plurality of information sources, information related to current events;
train a diffusion model with the collected information related to current events;
identify a topic of interest from the collected information related to current events;
generate content elements for the electronic game based on the identified topic and the diffusion model; and
update the electronic game with the generated content elements.

11. The system of claim 10, wherein the collected information related to current events comprises images.

12. The system of claim 11, wherein training the diffusion model with the collected information related to current events further comprises introducing noise to the images prior to training the diffusion model with the images.

13. The system of claim 10, wherein the collected information related to current events comprises video.

14. The system of claim 10, wherein the collected information related to current events comprises audio.

15. The system of claim 10, wherein the collected information related to current events comprises social media content.

16. The system of claim 10, wherein the collected information related to current events comprises search engine keywords.

17. A system comprising:
a communications network;
a gaming system coupled with the communications network and executing an electronic game, the electronic game comprising a plurality of content elements;
a game content host system coupled with the communications network, the game content host system comprising a processor and a memory coupled with and readable by the processor and storing therein a set of instructions which, when executed by the processor, causes the processor to:
collect from a plurality of information sources, information related to current events;
train a diffusion model with the collected information related to current events;
identify a topic of interest from the collected information related to current events;
generate a plurality of updated content elements for the electronic game based on the identified topic and the diffusion model; and
apply the plurality of updated content elements to the electronic game.

18. The system of claim 17, wherein the plurality of content elements of the electronic game represent a theme for the electronic game and wherein the plurality of updated content elements represent a new theme for the electronic game related to the identified topic of interest.

19. The system of claim 17, wherein the instructions further cause the processor to, prior to applying the plurality of updated content elements to the electronic game, providing the plurality of updated content elements as a recommendation for a change to the electronic game.

20. The system of claim 17, wherein the plurality of information sources comprises information sources for a geographic location in which the gaming system is installed.
